(19) United States
(12) Patent Application Publication
(10) Pub. No.: US 2022/0195799 A1
(43) Pub. Date: Jun. 23, 2022

(54) Reflective Rope Ladder

(71) Applicant: Ashot Aroian, MIAMI, FL (US)

(72) Inventor: Ashot Aroian, MIAMI, FL (US)

(21) Appl. No.: 17/129,980

(22) Filed: Dec. 22, 2020

(51) Int. Cl. E06C 1/56; D07B 1/02; D07B 5/00; E06C 7/00

(52) U.S. Cl. CPC E06C 1/56; D07B 1/02; D07B 5/00; E06C 7/003; D10B 2401/20; D07B 2201/104; D07B 2501/2069; D10B 2211/04; D07B 2205/103

(57) ABSTRACT

Embodiments disclose a reflective rope assembly consisting of a ladder comprised of two heavy duty safety carabiners, a series of anti-slip PVC rungs, attached to the flexible rope side supports which has reflective silk strands braided in for the purpose of reflecting light in nighttime/dark environment. The fire escape ladders doesn't require any assembly. The safety hooks allow for the ladder to be quickly attached to a window or a balcony railing in multiple ways. The ladder is fully deployed when the hooks are secured, and the ladder is lowered out of a window or a balcony to allow a safe descend.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to ladders and more particularly, to flexible rope ladders with reflective silk strands braided in for the purpose of reflecting light in night time/dark environment.

### Description of the Related Art

There has recently developed a recognition of the need for a variety of safety equipment, especially adapted for home use. In short, there is a greater degree of public recognition of safety requirements for homeowners, apartment dwellers, and for commercial tenants in large multi-story commercial facilities. This is especially true in connection with fire safety equipment, in view of the excessive numbers of fires which occur yearly, and the numbers of people who are injured or killed in connection with home and apartment fires.

In this connection, a variety of escape devices have been manufactured and sold particularly to homeowners and apartment dwellers, for use in connection with fires. A typical piece of equipment, which is currently available, consists of a ladder formed by a pair of parallel chains having wood or metal slats interconnecting the parallel chains thereby to create a ladder which may be employed in the event of an emergency. The top of the ladder generally has a rigid metal framework which is intended to be hooked over the window sill, and the user then simply throwing the lower portion of the ladder out of the window until the same extends downwardly the full length thereof.

Another version of an escape ladder is known and presently commercially available and is basically similar to the chain configuration described above, with the exception that rope is used for the long parallel sides of the ladder, with shorter lengths of rope being tied between the parallel lengths to form steps. Once again, either a framework is employed at the top end of the ladder, or each of the upper ends of the long parallel lengths of rope are provided with eyelets thereby intending that the upper end of the ladder be connected to an internal structure, with the balance of the ladder being displayed from the window to form an escape route.

There are multiple solutions that have been presented in prior art regarding advancements in ladder systems. For instance, an Escape soft ladder bearing Chinese patent 1,020,52051B is issued to Chinese inventor. The invention discloses an escape soft ladder, in particular to an emergency escape soft ladder for firefighting two building floors. The escape soft ladder is produced by excellent steel wire ropes or soft steel wire ropes or thinner excellent chains and is hung upside down and arranged on the roofs of high buildings or vertical shafts or can be temporarily arranged; and a winch can be manually or electrically operated, folded at normal times and well maintained in a firefighting escape soft ladder chamber for strictly prohibiting the use. The winch can be used only when people cannot escape from other exits after fire occurs and can be used in high buildings with over 100 stories. The method has favorable effect and is especially economic; the escape soft ladder is a necessary firefighting article of the high buildings which are provided with an automatic continuously-circulating escape soft ladder. The escape soft ladder has simple manufacturing and using technology, can automatically descend and can be manually braked after power failure and is not limited by the height. Ladder columns are soft bodies and are hung upside down above and can be released from the high building with over 100 stories. The automatic soft ladder can be safely and reliably continuously used and can be used for quickly evacuating escapers going downstairs. The two soft ladders can be respectively used in the state without power machines.

Another patent on Rope ladder for rescue of people from burning multi-story and altitude residential houses and buildings when extinguishing fires and other disasters bearing Russian patent 7,301,3U1 is issued to Russian inventor. The novelty and difference of the rope-and-rope rescue ladder, from similar means of salvation, lies in the fact that it is designed for the mass salvation of people, there is no other such tool in the world yet. This ladder immediately solves the problem of saving people in emergency situations on a national scale, as it is easy to manufacture and inexpensive, which allows each family and organization to purchase this rescue tool and have it in case of unforeseen dangerous situations (fire, explosion etc.). This rope-rope ladder, according to calculations, can withstand from 5 to 8 people being rescued simultaneously, and this averages 640 kg=80 kg (estimated weight of one person)*8, plus an allowable strength standard of 360 kg, total=640 kg+360 kg=1000 kg (one ton). The hemp rope itself is very strong and strong, as evidenced by archaeological excavations in Egypt, where hemp ropes were used to move blocks of up to 10 tons in weight, as well as studies of modern physics, when the level of strength can be measured using the most accurate scientific instruments. The described ladder is made of threads reinforced with thin wire and metals metallized with carbonyls, therefore, it is especially strong and strong, able to withstand even 10-12 people in emergency cases. As a result, the rope-rope rescue ladder allows you to save people in fires and other emergency situations with a 100% guarantee. If we provide each organization, family, firefighters, Ministry of Emergencies with a sufficient number of stairs, as well as train citizens and special services in the methods of its use, then the problem of saving people during fires and emergencies (explosions, collapse of buildings, etc.) will be solved most guaranteed and cheap way. The rapid introduction of the production of this life-saving tool, the rope-ladder, can save thousands of lives, which is the most important in the development and implementation of this purpose. The rescue of people in distress, especially on the upper floors of buildings affected by emergency, with a 100% guarantee—this is the uniqueness of this invention—the rope-ladder.

Another advancement is a Flexible stile or rope ladder for climbing poles or like members bearing U.S. Pat. No. 4,139,079A is issued to Trevor Clark. The patent is on a flexible stile ladder is disclosed wherein the midpoints of the ladder steps or rungs are slidably connected to the pole. Preferably, the slidable connectors are slides which operate in a track carried by the pole. The invention is particularly useful for climbing masts of sailboats.

Another patent on Rope ladder bearing U.S. Pat. No. 8,127,892B2 is issued to Dan Heiduk. The patent relates to a method and apparatus for providing a flexible ladder for traversing a structure that addresses problems common with conventional rope ladders.

A Parent-child chair with rope ladders bearing Chinese patent 2,031,37661U is issued to Chinese inventor. The utility model discloses a parent-child chair with rope ladders. The parent-child chair is characterized in that two vertical columns are arranged on a chair surface of the chair through rivets; a transverse rod is arranged on the tops of the vertical columns; the middle of the transverse rod is provided with a parallel column parallel to the vertical columns; the bottom of the parallel column is connected with a connection rod on chair legs; the rope ladders are arranged between the vertical columns and the chair legs; and rolling wheels are arranged at the bottoms of the chair legs of the chair. The parent-child chair has the beneficial effects that when a parent sits on the chair, a child can climb the rope ladders on the chair and enjoy the climbing, so that the parent can supervise the safety of the child at any time while playing a parent-child game with the child.

Another patent on Rope Ladders bearing GB patent 1,197,060A is issued to William Charles Coombs. The patent is on a rope ladder has the rungs 6 attached to the rope stiles by plugs 12 which are inserted in either dead-end bores 11 (as shown) or through-bores in the rungs, with the outer part of their length exposed in plan by axial slots in the rungs, said outer part having a peripheral groove 4 fixed in the rope stile, and an end recess 12, and being rivetted at 14 to the rung. The rungs and plugs may be of metal and the rungs may be ridged. The ropes may be of four strand V-plaited construction, preferably of polypropylene. The plugs may alternatively be welded, glued or screwed to the rungs.

A British patent 9,356,45A on improvements relating to rope ladders is issued to Dunlop Rubber Co Ltd. The patent is on an advancements where steps of a rope ladder are made of rubber &c. and have guides 7, 8 extending along the ropes to keep the steps in the correct position. The guides 7, 8 taper away from the steps and two ropes 3 at each side of the ladder pass through holes in the steps and each rope engages a groove on the sides of the guides and the ropes are bound together above and below the guides by cords 9. The upper surfaces of the steps have ribs 4-6.

Another patent on Emergency escape ladder bearing Chinese patent 2,031,29935U is issued to Chinese inventor. The utility model discloses an emergency escape ladder. The emergency escape ladder comprises a plurality of pedals, connecting ropes and fixed hooks, wherein an outward-inclined baffle is arranged at each of the front side and the rear side of each pedal respectively, and the pedals and the baffles form trapezoidal structures in which the upper parts are narrow and the lower parts are wide; connecting holes for being penetrated by the connecting ropes and fixing the pedals are formed in two ends of the pedals, thus forming a flexible ladder provided with multistage pedals; the fixed hooks are fixedly connected to the face of one pedal on the top of the emergency escape ladder; and anti-shake adhesive tapes are arranged below the outer sides of the baffles. By utilizing the technical scheme, the emergency escape ladder has the advantages that the mechanism is simple, compact, safe and reliable, the space is saved, the appearance is beautiful, and the containing and the storing are conveniently carried out; and as the friction force between the emergency escape ladder and the wall is enhanced by the anti-shake adhesive tapes, the shaking feel generated when a user climbs the ladder downwards is effectively reduced, and the safety factor during escaping of the user is increased.

There are multiple solutions that have been presented in prior art. However, these solutions are limited and restricted to further technological advancements. Therefore, these safety devices require basic improvements to be more convenient and useful for the users.

Looking at prior art, some rope ladders are arranged at present on the market, where the emergent use is when fire is in high buildings, but there are structure and complicated operation, be not suitable to be used when escape is required.

Similarly, the inexperience people, children or adult people especially at dark are really puzzled to find the next step in such a volatile situation which can also lead to other hazardous and unsafe conditions.

To overcome the above-mentioned problem and provide advancement in similar field, the current invention is focused on presenting an assembly which is directed to a rope ladders for climbing/fire escape, with a unique feature: the ropes of the ladder have a reflective silk strands braided in for the purpose of reflecting light in nighttime/dark environment. The aforementioned invention as described above is an advancement where the advancement is the silk strands braided for the purpose of reflecting light in night time/dark environment. If a user has to deploy a ladder which is supposed to be hung outdoors it allows for other people around to notice and the user himself will have a better visibility which provides a safer descend.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a Rope ladder for escaping from any type of house or building blocked by fire or any other hazardous situation.

Another object of this invention is to provide a new and improved ropes of the ladder with reflective silk strands braided in for the purpose of reflecting light in night time/dark environment.

It is another object of the present invention to provide an improved assembly with a flexible rope ladder formed by a main piece of braided and stranded rope, and having a plurality of loops formed from a braided stranded material connected to the main piece of braided and stranded rope by interweaving the braided stranded material of each of the loops to the main piece of rope, each of the sequential loops being disposed in a 180° juxtaposition relative to the vertically adjacent loop located on the main piece of rope.

It is yet another object of the present invention to provide an improved assembly which provides better visibility and provides a safer descend.

It is also the object of the present invention to provide a weight capacity of this ladder is 2000 lb.

It is further the objective of the invention to provide an assembly which does not damage various configurations with which it is attached and the constituent members are simple, easy to process, low in manufacturing cost, durable and highly applicable.

It is another objective of the invention to provide a main assembly made of high-quality materials aimed to provide an improved assembly and can be utilized for longer period of time without effecting its performance.

It is also the object of the invention to provide an assembly which is consistent, reusable and can very simply and safely be manipulated by the average household user without other equipments, training or more than ordinary dexterity.

It is also the objective of the invention to provide a smart assembly which provide ease of use and convenience to the user.

Thus, it is the objective to provide a new and improved reflective rope mat assembly with enhanced visibility. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a partial top view of the reflective rope ladder.

FIG. 2 is a partial close up view of the braided rope.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an improved smart rope ladders for climbing/fire escape, with a unique feature: the ropes of the ladder have a reflective silk strands braided in for the purpose of reflecting light in night time/dark environment.

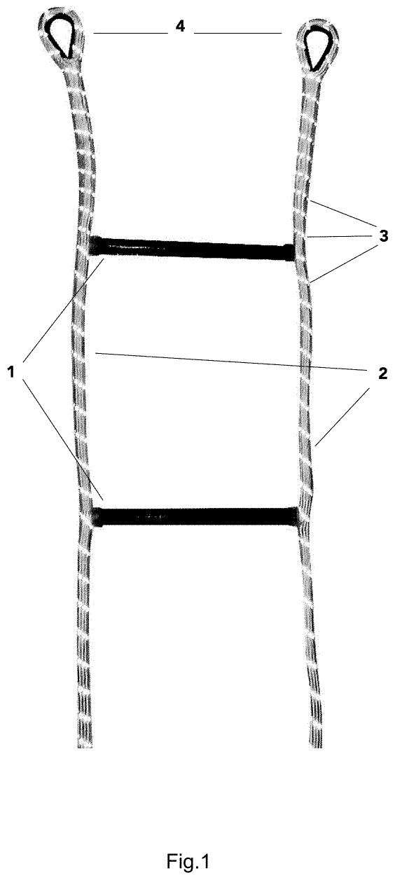

Referring to FIG. 1 a flexible rope ladder as shown comprises of a series of anti-slip PVC rungs (1) which are attached to the flexible rope side supports (2) which has reflective silk strands (3) braided in for the purpose of reflecting light in nighttime/dark environment. The fire escape ladders doesn't require any assembly. The upper end of the rope ladder includes a top end which is formed into a closed loop (4) and spliced downwardly into the main rope, such that the splicing is in a direction 180° away from the direction of the force of stress during use. Similarly, each of the loop members is interwoven into the main length of rope, the interweaving being constructed and designed to be 180° against the direction of the force during use, thereby to increase the strength of the entire rope ladder during use. The upper loops allow for the ladder to be quickly attached to a window or a balcony railing in multiple ways such as using snap hooks. The ladder is fully deployed when the hooks are secured, and the ladder is lowered out of a window or a balcony to allow a safe descend.

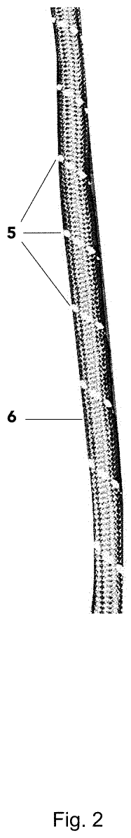

The assembly as per its preferred embodiments is to provide a flexible rope as shown on FIG. 2 with reflective silk strands (5) which is formed from a single main piece of rope (6), and having a plurality of loop members interwoven and braided into the main piece of rope, such that when completed, the entire rope ladder is of unitary construction.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A rope ladder with reflective silk stands comprising:
a main rope piece formed of a twisted, stranded fibrous material mostly reflective silk strands, said main rope piece including a top end and a bottom end,
a plurality of short rope pieces formed from a twisted and stranded fibrous material mostly reflective silk strands, each of said short rope pieces including opposed ends,
Where each of said short rope pieces including one end securely connected to said main rope piece by interweaving the braided and stranded fibrous material of reflective silk strands forming said short rope piece with the twisted and stranded fibrous material forming said main rope piece,
each of the plurality of short rope pieces thereby creating a plurality of loops along the length of said main rope piece,
and each of said plurality of loops being sequentially positioned on opposed sides of said main rope piece in alternating fashion along the length thereof,
each succeeding loop secured to said main rope piece being 180° out of the plane of the immediately previous vertically positioned loop whereby said loops are positioned in alternating side to side relationship along the entire length of said main rope piece.

2. A rope formed with reflective material particularly reflective silk strands braided in for the purpose of reflecting light in nighttime/dark environment. This is particularly useful to assist user in night time or darkness when descending from any hazardous situation.
